(19) United States
(12) Patent Application Publication
(10) Pub. No.: US 2005/0269744 A1
(43) Pub. Date: Dec. 8, 2005

(54) Stretched container and method of manufacture

(76) Inventor: Michael J. Lonsway, Toledo, OH (US)

Correspondence Address: KUDIRKA & JOBSE, LLP, ONE STATE STREET, SUITE 800, BOSTON, MA, 02109, US

(21) Appl. No.: 10/862,226

(22) Filed: Jun. 7, 2004

(51) Int. Cl. B29C 55/22

(52) U.S. Cl. 264/320; 425/393

(57) ABSTRACT

An apparatus and method of forming a container from a preform having a closed end, an oppositely disposed open end, a body portion extending from the closed end and terminating in a neck finish portion at the open end, the preform having at least one inner diameter. A mandrel is provided having a tapered portion at one end thereof and at least one outer diameter greater in size than the at least one inner diameter of the preform. The mandrel is moved into the open end of the preform to expand the neck finish portion of the preform. The mandrel is further moved into the preform to also expand the body portion of the preform until the one end of the mandrel at least partially forms the closed end of the preform into an at least partially formed closed end of the container, after which the mandrel is removed from the container. According to a preferred embodiment of the present invention, the tapered portion of the mandrel may be collapsible into a body portion of the mandrel in order to finish form the closed end of the preform.

The present invention is directed to molded plastic containers and to methods of manufacturing such containers, and is more specifically directed to molded plastic jars, bowls, cans and other “wide-mouth” containers and to methods of manufacturing such containers.

### BACKGROUND AND SUMMARY OF THE INVENTION

In the manufacture of plastic containers, such as monolayer or multilayer polyethylene terephthalate (PET) containers, it is conventional to injection or compression mold a container preform having a body and a neck finish with one or more external threads. In the manufacture of jars and the like, the finish and body are typically molded to an initial size and geometry that is conducive to high throughput molding operations. Subsequently, the finish and body are blow molded to their final desired size and geometry in accordance with the desired container body. While this manufacturing technique is satisfactory for fabrication of the body portion, it is less than satisfactory for fabrication of the threads of the finish. Typically, blow molding processes do not yield finish threads having the sharp definition and detail that is required of a finished container.

To address this manufacturing problem, a preform is molded to have a narrow-neck finish, and then the finish is stretched to a final size using a separate stretched finish machine, either before or after the blow molding operation. Although this technique permits use of narrow-neck preforms, and thus maintains high throughput during the preform molding stage, the technique has the disadvantage of adding another manufacturing step and related equipment to the container manufacturing process, which tends to increase product costs and decrease process throughput.

An apparatus in accordance with one aspect of the invention is provided for forming a container from a preform having a closed end, an oppositely disposed open end, a body portion extending from the closed end and terminating in a neck finish portion at the open end, and at least one inner diameter. The apparatus includes a mandrel having a tapered portion at one end. The tapered portion has an outer diameter greater in size than the at least one inner diameter of the preform. The tapered portion is movable into the open end of the preform so that the mandrel is received within the preform in order to expand both the finish portion and the body portion of the preform into stretched finish and body portions of the container and in order to form an at least partially formed closed end. According to a preferred embodiment of the present invention, the tapered portion of the mandrel may be collapsible into a body portion of the mandrel in order to finish form the closed end of the preform.

In accordance with a second aspect of the invention, there is provided a method of forming a container from a preform having a closed end, an oppositely disposed open end, and a body portion extending from the closed end and terminating in a neck finish portion at the open end, the preform having at least one inner diameter. According to the method, a mandrel is provided having a tapered portion at one end thereof and at least one outer diameter greater in size than the at least one inner diameter of the preform. The mandrel is moved into the open end of the preform to expand the neck finish portion of the preform. The mandrel is further moved into the preform to also expand the body portion of the preform until the one end of the mandrel at least partially forms the closed end of the preform into an at least partially formed closed end of the container. The mandrel is then removed from the container. According to a preferred embodiment of the present invention, the tapered portion of the mandrel may be collapsible into a body portion of the mandrel in order to finish form the closed end of the preform.

### BRIEF DESCRIPTION OF THE DRAWINGS

The invention, together with additional objects, features, advantages and aspects thereof, will be best understood from the following description, the appended claims and the accompanying drawings, in which:

FIG. 1A is a schematic diagram of a pre-heating step for pre-heating a preform according to methods of exemplary embodiments of the present invention,

FIG. 1B is a partial cross-sectional schematic view of the preform of FIG. 1 and a solid mandrel for stretching the preform in accordance with one method of an exemplary embodiment of the present invention,

FIG. 1C is a partial cross-sectional schematic view of the preform and mandrel of FIG. 2, at an intermediate stage wherein the mandrel is being moved into the preform to stretch the preform,

FIG. 1D is a cross-sectional schematic view of a container having a tapered closed end that is produced by the apparatus and method steps depicted in FIGS. 1A-1C,

FIG. 2A is a partial cross-sectional schematic view of the container of FIG. 1D and a second mandrel for further stretching the preform in accordance with another method of another exemplary embodiment of the present invention,

FIG. 2B is a partial cross-sectional schematic view of the second mandrel having been fully moved into the container of FIG. 2A to establish a container having a flat closed end,

FIG. 2C is a cross-sectional schematic view of the container produced by the apparatus and method steps depicted in FIGS. 1A-2B,

FIG. 3A is a partial cross-sectional schematic view of a preform and a collapsible mandrel for stretching the preform in accordance with a further method of a further exemplary embodiment of the present invention,

FIG. 3B is a partial cross-sectional schematic view of the collapsible mandrel having been fully moved into the preform of FIG. 3A to establish a container having a flat closed end,

FIG. 3C is a cross-sectional schematic view of the container produced by the apparatus and method steps depicted in FIGS. 1A, and 3A-3B, and

FIG. 4 is a cross-sectional view of the collapsible mandrel of FIG. 3A, taken along line 4-4 thereof.

### DETAILED DESCRIPTION OF PREFERRED EMBODIMENTS

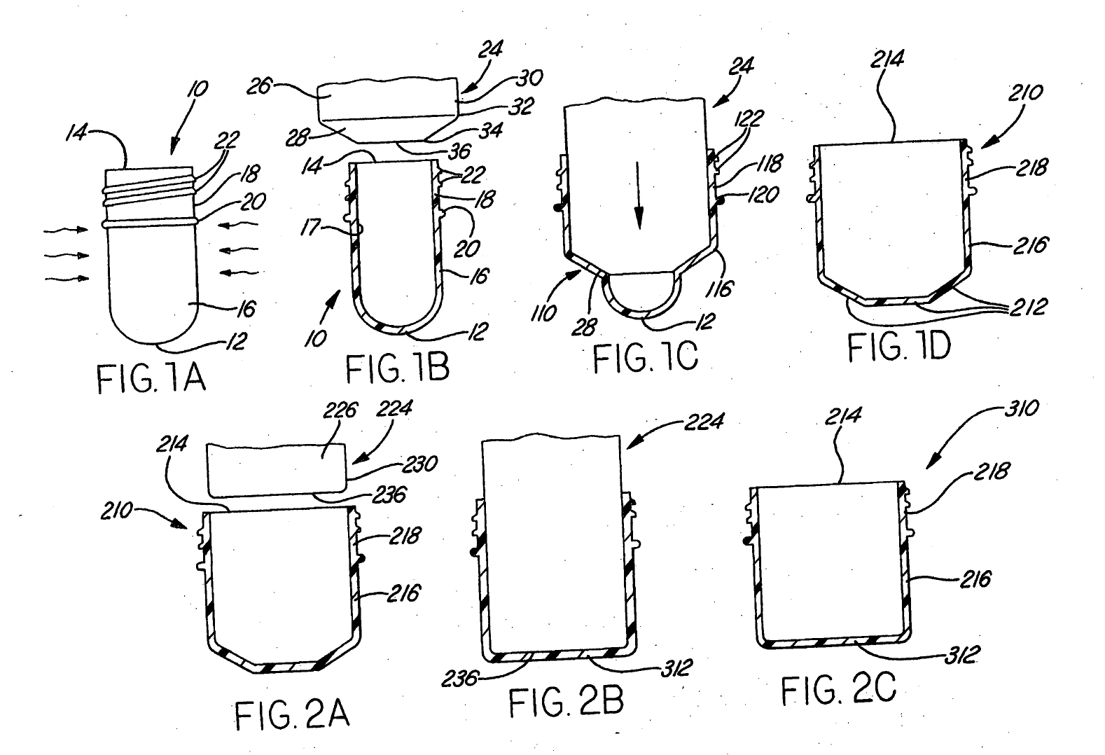

FIG. 1A illustrates an initial method step of the present invention wherein a preform 10 is being pre-heated by any desired pre-heating means (not shown). Various pre-heating means are widely known to those of ordinary skill in the art, such as quartz lamp radiative heating means, induction heating means, resistance heating means embedded in tooling, and the like.

As shown in FIGS. 1A and 1B, the preform 10 includes a closed end 12, an oppositely disposed mouth or open end 14, a body portion 16 that is integral with and that extends axially away from the closed end 12, and a neck finish portion 18 that terminates the body portion 16 at the open end 14 of the preform 10. The finish portion 18 includes a capping or support flange 20 and one or more attachment features such as external threads or thread segments 22. The preform 10 may be of any suitable plastic construction, such as monolayer PET or polypropylene (PP), or a multilayer construction of PET or PP layers alternating with intermediate layers preferably layers of barrier resin such as ethylene vinyl alcohol (EVOH) or nylon. Such intermediate layer or layers may be disposed in the preform body portion 16, and may or may not extend into the preform neck finish portion 18. Post consumer resin (PCR) layers also can be employed. The preform 10 may be injection molded or compression molded and may be composed of different materials in different locations. For example, the body may be composed of PET, while the finish portion is composed of PET, post consumer resin (PCR), process regrind (REG), polypropylene (PP), polyethylene (PE), polyethylene naphthalate (PEN), or the like. Moreover, where the neck finish portion 18 is of polyester construction (e.g., PET, PEN or process regrind), the neck finish portion 18 may be wholly or partially crystallized as molded. This may be accomplished by employing fast-crystallizing materials or suitably setting process conditions for manufacture of the neck finish portion 18, such as high mold temperature, slow mold cooling, heated areas in the mold tooling, etc. The neck finish portion 18 alternatively may be wholly or partially crystallized in a post-molding operation. It will be understood that the present invention is by no means limited to these exemplary materials and treatments.

In any case, and as shown in FIG. 1B, a solid mandrel 24 is positioned in substantial coaxial alignment with the preform 10 over the open end 14 thereof. The mandrel 24 includes a body portion 26 and a tapered portion 28. The body portion 26 has an outer diameter 30 and the tapered portion 28 has a variable diameter that is defined by a maximum diameter 32, which is substantially equal in size to the outer diameter 30 of the body portion 26, and by a minimum diameter 34 at a flat end 36 of the tapered portion 28. The outer diameter 30 of the mandrel 24 is greater in size than an inner diameter 17 of the preform 10. Once the mandrel 24 is in position as shown, the mandrel 24 is moved toward the preform 10 and into the open end 14 thereof.

As shown in FIG. 1C, the mandrel 24 moves to radially and circumferentially draw or stretch the neck finish portion 18 of the preform 10 of FIG. 1B to create a stretched neck finish portion 118 of a partially drawn or stretched preform 110. The neck finish portion 118 now has a stretched flange 120 and stretched external threads 122, which are similar in geometry to the preform external threads 22 of FIG. 1B. In other words, the external threads 122 are radially outwardly displaced and stretched as compared with the preform threads 22 of FIG. 2B, but otherwise have a geometry determined by the geometry of the preform threads 22 as molded, which are more sharply defined and detailed than threads that can otherwise be obtained by blow molding. Accordingly, the preform threads 22 and neck finish 18 should be larger and thicker than the final desired size of the stretched threads 122 and neck finish 118 to arrive at the proper dimensions after stretching. As noted above, the preform neck finish 18 can be heated prior to or during stretching, such as by conduction from a heated mandrel 24 and/or by other means such as radiant heating, etc. Stretching of the preform neck finish 18 and threads 22 achieves advantageous molecular orienting and strength in the stretched neck finish 118 and threads 122. It is also envisioned that the neck finish 18, 118 can be wholly or partially crystallized during or after expansion to prevent substantial relaxation and shrinkage, particularly for hot-fill applications. Such crystallization can be on the exterior surface of the neck finish 18, 118 including the threads 22, 122, or may extend entirely through the thickness of the neck finish 18, 118. Such crystallization can be carried out either simultaneously with or subsequent to expanding the preform neck finish 18 and stretching the preform finish threads 22.

As also shown in FIG. 1C, the mandrel 24 further moves into the partially stretched preform 110 to radially and circumferentially draw or stretch the body portion 16 of the preform 10 of FIG. 1B to create a stretched body portion 116. The mandrel 24 moves until the flat end 36 of the mandrel 24 at least partially forms or flattens out the contoured closed end 12 of the partially stretched preform 110.

FIG. 1D illustrates the result of the preceding method steps and apparatus, wherein a container 210 is produced having an open end 214, a stretched neck finish portion 218, a stretched body portion 216, and a partially formed closed end 212, which is partially tapered as an example. The container 210 is preferably ajar, bowl or the like, but is not limited thereto. For some product applications, the container 210 may be considered unfinished until the tapered closed end 212 is substantially flattened out. Accordingly, FIGS. 2A-2C illustrate another embodiment of the present invention.

FIG. 2A illustrates the tapered closed-end container 210 of FIG. 1C and a second solid mandrel 224 positioned in substantial coaxial alignment with the container 210 over the open end 214 thereof. The second mandrel 224 includes a body portion 226 having an outer diameter 230 that is preferably substantially similar, if not equal, in size to the outer diameter 30 of the first mandrel 24 of FIGS. 1B-1C. The outer diameter 230 may, but need not, further radially and circumferentially expand the neck finish portion 218 or body portion 216 of the container 210. The second mandrel 224 also includes a finish form end 236 that is, for example, substantially flat. The finish form end 236 may alternatively include radii, concave portions, and the like, and it preferably encompasses any geometry that will sustain a container in an upright orientation while resting on a flat surface, but is not limited thereto. Once the mandrel 224 is in position as shown, the mandrel 224 is moved toward the container 210 and into the open end 214 thereof. The second mandrel 224 moves into the preform 210 wherein the flat end 236 of the mandrel 224 radially and circumferentially draws or stretches the container 210 to finish form or flatten the tapered closed-end 212 of the container 210 to create a substantially finished closed end 312, which may be substantially flat as shown in FIG. 2B. FIG. 2C illustrates the result of the preceding method steps and apparatus, wherein a finished container 310 is produced having the open end 214, the previously stretched neck finish portion 218, the stretched body portion 216, and the newly finished or flattened closed-end 312.

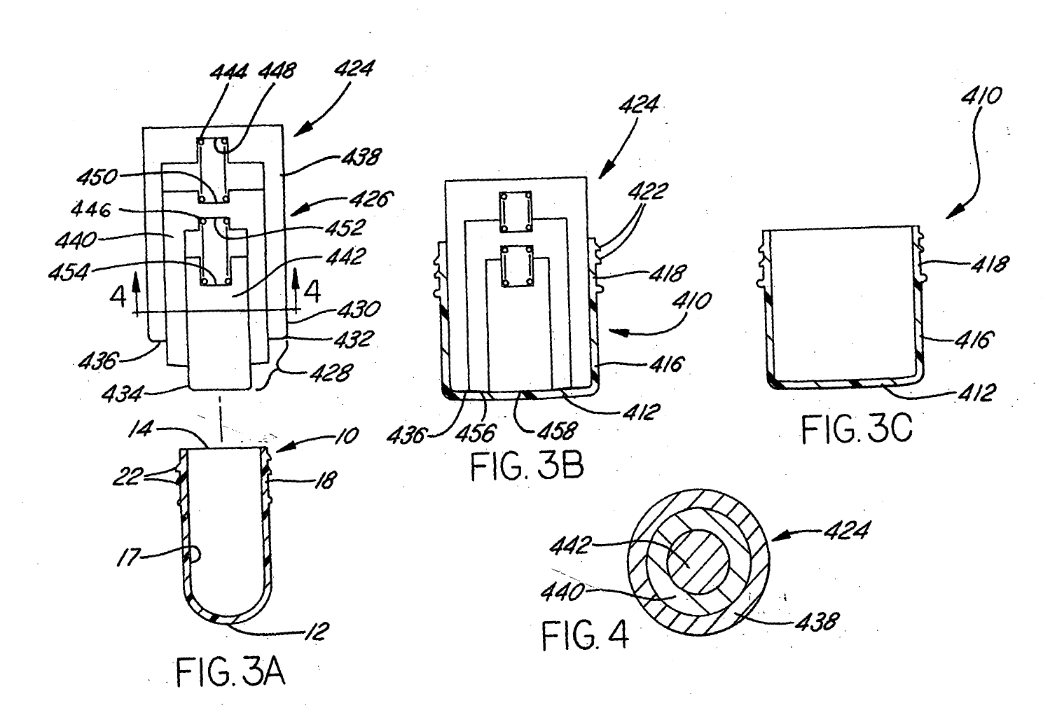

FIGS. 3A-4 illustrate an apparatus and depict method steps according to another exemplary embodiment of the present invention. FIG. 3A illustrates the same preform 10 as that of FIGS. 1A and 1B. However, FIG. 3A illustrates a telescoping or collapsible mandrel 424 having a body portion 426, a tapered portion 428, and a substantially flat end 436. The body portion 426 has an outer diameter 430, and the tapered portion 428 has a variable diameter that is defined by a maximum diameter 432, which is substantially equal in size to the outer diameter 430 of the body portion 426, to a minimum diameter 434. One or more of the diameters of the mandrel 424 is greater in size than the inner diameter 17 of the preform 10. Preferably, the minimum diameter 434 is slightly greater in size than the inner diameter 17 of the preform 10. As also shown in FIG. 4, the mandrel 424 includes a body or outer sleeve 438, an inner sleeve 440 movably disposed within the outer sleeve 438, and an inner core 442 movably disposed within the inner sleeve 440. In FIG. 3A, a first spring 444 is disposed between the inner and outer sleeves 440, 438 to bias the inner sleeve 440 toward an extended position as shown. Similarly, a second spring 446 is disposed between the inner core 442 and inner sleeve 440 to bias the inner core 442 toward an extended position as shown. The inner and outer sleeves 440, 438 and the inner core 442 are relieved with spring pockets 448-454 to accommodate the collapsed height of the springs 444, 446 when the inner core 442 and inner sleeve 440 are collapsed into the outer sleeve 438.

In process, and with reference to FIGS. 3A and 3B, the collapsible mandrel 424 is positioned in substantial coaxial alignment with the preform 10 over the open end 14 thereof. Once the mandrel 424 is in position as shown, the mandrel 424 is moved toward the preform 10 and into the open end 14 thereof. The mandrel 424 radially and circumferentially draws or stretches the neck finish portion 18 of the preform 10 of FIG. 3A into a stretched neck finish portion 418 of a stretched container 410 of FIG. 3B. The neck finish portion 418 now has stretched external threads 422, which are similar in geometry to the preform external threads 22, but are radially and circumferentially expanded along with the rest of the neck finish portion 418. Thus, the external threads 422 are expanded or stretched as compared with preform threads 22. The mandrel 424 further moves deeply into the preform 10 to radially and circumferentially draw or stretch the body portion 16 until the tapered portion 428 of the mandrel 424 collapses. The mandrel 424 collapses such that the inner core 442 first bottoms out against the closed end 12 of the preform 10 and subsequently collapses within the inner sleeve 440. Subsequently, the inner sleeve 440 bottoms out against the closed end 12 of the preform 10 and then collapses within the outer sleeve 438. Finally, the outer sleeve 438 contacts the closed end 12 of the preform 10, and the flat end 436 of the outer sleeve 438, along with the flat ends 456, 458 of the inner sleeve 440 and inner core 442, stretches the preform 10 to create the flat closed-end 412 of the container 410 of FIG. 3B. It is contemplated that one or more of the sleeves 438, 440 and core 442 could be conically tapered, if desired, to provide a more gradual lead in of the mandrel 424 into the preform 10. More specifically, both the inner sleeve 440 and inner core 442 could be conically tapered so as to provide a continuous taper from the flat end 458 of the inner core 442 to the flat end 436 of the mandrel 424.

FIG. 3C illustrates the result of the preceding method steps and apparatus, wherein the container 410 is produced having the stretched neck finish portion 418, stretched body portion 416, and flat closed-end 412.

There have thus been described a container, and a method and apparatus for making the container that fully satisfy all of the objects and aims previously set forth. The present invention has been disclosed in conjunction with presently preferred embodiments thereof, and a number of modifications and variations have been discussed. Other modifications and variations will readily suggest themselves to persons of ordinary skill in the art in view of the foregoing description. For example, the invention has been disclosed in conjunction with a mandrel movable with respect to a preform. However, the present invention contemplates use of a stationary mandrel and a preform movable with respect to the mandrel. Such alternatives can be provided without departing from the disclosure. Directional words such as top, bottom, upper, lower, radial, circumferential, and the like are employed by way of description and not limitation. Indeed, the invention is intended to embrace all modifications and variations as fall within the spirit and broad scope of the appended claims.

1. Apparatus for forming a container from a preform having a closed end, an oppositely disposed open end, a body portion extending from said closed end and terminating in a neck finish portion at said open end, said preform having at least one inner diameter, said apparatus including:
a mandrel having a tapered portion at one end,
said tapered portion having an outer diameter greater in size than said at least one inner diameter of said preform,
said tapered portion being movable into said open end of said preform, so that said mandrel is received within said preform in order to expand said neck finish portion and also said body portion of said preform into stretched finish and body portions of said container and in order to form an at least partially formed closed end.

2. The apparatus set forth in claim 1, wherein said mandrel has a body portion, and said tapered portion is movable between an extended position in which said tapered portion is extended and a retracted position in which said tapered portion is collapsed into said body portion.

3. The apparatus set forth in claim 2, wherein said body portion is at least partially defined by an outer sleeve and said tapered portion is at least partially defined by at least one inner member disposed within said outer sleeve, said inner member being collapsible into said outer sleeve, said mandrel being movable into said body to said closed end of said preform until said at least one inner member collapses within said outer sleeve, and said outer sleeve and said at least one inner member substantially form a closed end of said container.

4. The apparatus set forth in claim 3 wherein said at least one inner member includes an inner sleeve disposed within said outer sleeve and an inner core disposed within said inner sleeve, such that said mandrel is movable into said body portion of said preform to said closed end of said preform until said inner core collapses within said inner sleeve and said inner sleeve collapses within said outer sleeve such that said outer sleeve, inner sleeve, and said inner core substantially form said closed end of said container.

5. The apparatus set forth in claim 1, including a second mandrel having a finish form end and at least one outer diameter substantially similar in size to said at least one outer diameter of said mandrel, wherein said second mandrel is movable into said open end of said container to further form said at least partially formed closed end of said preform until said finish form end of said second mandrel finish forms said at least partially formed closed end of said container to create a substantially finished closed end of said container.

6. A method of forming a container from a preform having a closed end, an oppositely disposed open end, a body portion extending from said closed end and terminating in a neck finish portion at said open end, said preform having at least one inner diameter, said method including the steps of:
(a) providing a mandrel having a tapered portion at one end thereof and at least one outer diameter greater in size than said at least one inner diameter of said preform,
(b) moving said mandrel into said open end of said preform to expand said neck finish portion of said preform,
(c) further moving said mandrel into said preform to also expand said body portion of said preform until said one end of said mandrel at least partially forms said closed end of said preform into an at least partially formed closed end of said container, and
(d) removing said mandrel from said container.

7. The method set forth in claim 6, wherein said container includes said at least partially formed closed end, an oppositely disposed open end, a body portion extending from said at least partially formed closed end and terminating in a finish portion at said open end, said method including the steps of:
(e) providing a second mandrel having a finish form end and at least one outer diameter substantially similar in size to said at least one outer diameter of said mandrel,
(f) moving said second mandrel into said open end of said container to finish form said at least partially formed closed end of said preform to create a finished closed end of said container, thereby finishing said container, and
(g) removing said second mandrel from said container.

8. The method set forth in claim 6, wherein said tapered portion of said mandrel is collapsible and wherein said step (c) of further moving said mandrel into said preform also includes further moving said mandrel to further expand said body portion of said preform until said tapered portion of said mandrel collapses, thereby forming a finished closed end of said container having a diameter substantially similar to that of said at least one outer diameter of said mandrel.

9. The method set forth in claim 8 wherein said step (a) includes providing said mandrel having said tapered portion that is defined by an outer sleeve and at least one inner member, said inner member being collapsible into said outer sleeve, further wherein said step (c) includes continuing movement of said mandrel into said body portion of said preform to said closed end until said at least one inner member collapses within said outer sleeve, and said outer sleeve and said at least one inner member substantially form said finished closed end of said container.

10. The method set forth in claim 9 wherein said step (a) includes said tapered portion being defined by said outer sleeve and said at least one inner member, said at least one inner member includes an inner sleeve disposed within said outer sleeve and an inner core disposed within said inner sleeve, further wherein said step (c) includes continuing movement of said mandrel into said body portion to said closed end of said preform until said inner core collapses within said inner sleeve and said inner sleeve collapses within said outer sleeve such that said outer sleeve, inner sleeve, and said inner core substantially form said finished closed end of said container.

11. The method set forth in claim 6 including heating said preform prior to said step (b).

12. A container produced by the method set forth in claim 6.
